(19) United States
(12) Patent Application Publication
(10) Pub. No.: US 2021/0016877 A1
(43) Pub. Date: Jan. 21, 2021

(54) A STRUCTURE CONSTRUCTION FOR AN AIRCRAFT AND AIRCRAFT COMPRISING THE STRUCTURE CONSTRUCTION

(71) Applicant: LENTOLA LOGISTICS OY, Hämeenlinna (FI)

(72) Inventor: Markus Hohenthal, Hämeenlinna (FI)

(73) Assignee: LENTOLA LOGISTICS OY, Hämeenlinna (FI)

(21) Appl. No.: 16/979,888

(22) PCT Filed: Feb. 20, 2019
(86) PCT No.: PCT/FI2019/050134

§ 371 Date: Sep. 11, 2020

(30) Foreign Application Priority Data
Mar. 20, 2018 (FI) 20185256

(51) Int. Cl. B64C 29/00; B64C 1/06; B64C 1/26; B64D 27/02; B64C 3/38; B64C 25/60; B64D 11/00; B64D 27/24; B64D 31/00

(52) U.S. Cl. CPC B64C 29/0033; B64C 1/068; B64C 1/26; B64D 27/02; B64C 3/38; G01C 5/005; B64C 25/60; B64D 11/00; B64D 27/24; B64D 31/00; B64C 1/069

(57) ABSTRACT

A structure construction for an aircraft includes first and second fuselage portions and at least one wing. In addition, the structure construction includes a supporting structure for supporting the wing and the first fuselage portion. The supporting structure or the wing also includes at least one engine, Additionally, the supporting structure is configured to be hinged to the second fuselage portion so that the supporting structure allows turning of the wing and the first fuselage portion in relation to the second fuselage portion during take-off, landing positions and forward flying position.

### TECHNICAL FIELD OF THE INVENTION

The invention relates to a structure construction for an aircraft and to the aircraft comprising said structure construction. The structure construction comprises first and second fuselage portions and at least one wing. In particularly the invention relates to structure for the aircraft and aircraft performing vertical take-offs and landings (VTOL machine).

### BACKGROUND OF THE INVENTION

There are known structure constructions for aircrafts having first and second fuselage portions and at least one wing structure from prior art. In addition variety of VTOL flying machines are known from prior art, such as for example helicopters, but also smallish aircraft and drones, which are lifted in the air with propellers or fans. In addition there are aircrafts known from prior art, which are lifted in the air with propellers and which take-off and land vertically, but where the propellers are in a substantially horizontal position while cruising.

One problem with this type of aircraft is nevertheless for example how to move them after take-off from a vertical position to a horizontal flight position and, respectively, from a horizontal flight position to a vertical position for landing. Although, at least in principle, such aircraft are capable of operating (take-offs and landings) on patches of quite a small area, in practice they drag over quite a long distance before the airspeed is high enough to provide the control surfaces (e.g. the elevator) with a steering force sufficient for turning the machine for example to a cruising position. Likewise, the landing also requires in practice an area which is quite large with respect to a theoretically envisaged landing area, since the turning of such aircraft in a stationary condition for example around its longitudinal axis is difficult in a controlled manner.

### SUMMARY OF THE INVENTION

An object of the invention is to alleviate and eliminate the problems and disadvantages relating to the known prior art. For example the object of the invention is to provide a structure construction for an aircraft and the aircraft so to allowing the aircraft turning for example after take-off from a vertical position to a horizontal flight or cruising position and, respectively, from a horizontal flight position to a vertical position for landing effectively so that any sloping lines are minimised and so that the aircraft would turn to and from the horizontal flight or cruising position easily, quickly and with minimal power need. Moreover the object of the invention is to provide a simple and durable structure construction for VTOL purposes, which is stable to land and to be parked on the ground, but which is still at the same time very aerodynamic with low air resistance. Further the object is to provide the structure construction so that it is easy to load and unload and that the load would be located essentially at the same position during the whole flight (including take-off, forward flying, hovering and landing).

The object of the invention can be achieved by the features of independent claims.

The invention relates to a structure construction according to claim 1. In addition the invention relates to an aircraft according to claim 13.

According to an embodiment of the invention a structure construction for an aircraft, advantageously for aircrafts heavier than air, comprises first and second fuselage structure portions, and at least one wing. The wing might be e.g. a delta or trapeze wing, for example. In addition the wing may be configured to form at least portion of the supporting structure. In addition the structure construction comprises a supporting structure for supporting the wing and the first fuselage portion. The supporting structure or the wing is configured to be provided advantageously with at least one engine, advantageously main engine of the aircraft. The engine is advantageously an electric engine and provided with rotating propellers or fan. According to an embodiment the engine(s) produce(s) in connection with the supporting structure or wing at least ⅔ of the total thrust.

According to an advantageous embodiment the supporting structure is configured to be hinged to the second fuselage portion so that the supporting structure allows turning of said wing and said first fuselage portion in relation to the second fuselage portion to a take-off and landing modes or positions, and to forward flying or cruising mode. Advantageously the supporting structure, wing and the first fuselage portion are turned around the hinge as a one fixed packet or construction so that the first fuselage portion and the wing is a fixed entity or unit and not hinged or turnable in relation to each other. This makes the structure simple and very durable.

Advantageously the wing and the first fuselage portion are configured to be turned via help of the supporting structure essentially parallel to the longitudinal axis of the second fuselage portion in the forward flying mode, and in an angle, essentially perpendicular to the longitudinal axis of the second fuselage portion during landing and take-offs. This provides very aerodynamic structure, low air resistance and thus bigger air speed with relatively low engine power. In addition fuel consumption can be decreased by this structure when compared to structures known from prior art.

In addition the first fuselage portion is configured to be turned via help of said supporting structure to an upward direction in relation to said second fuselage portion during hovering, take-off and landing. According to an example the supporting structure, first fuselage portion and the wing are essentially perpendicularly in relation to the longitudinal axis of the second fuselage portion, but so that the first fuselage portion is essentially above the second fuselage portion and the second fuselage portion is at the lower level. This embodiment provides more stable structure to hovering, landing and taking off, because the center of gravity of the whole structure construction or aircraft is on a very low level for example compared to a front line of the engines or the leading edge of the wing, for example. It is to be noted that when the aircraft is parked the supporting structure may be held in the upward position or turned in the horizontal position.

According to an exemplary embodiment a cockpit and/or cabin or room for persons, as well as also main cargo is arranged in the second fuselage portion. The second fuselage portion (or its longitudinal axis) is advantageously configured to remain essentially in a horizontal position or plane both during take-off and landing as well as during flight, parking, loading and unloading. This provides very stable structure to land and to be parked on the ground, and in addition makes it easy to load and unload. In addition the cargo and the persons on the board will remain essentially at the same position during the whole flight, including also take-off and landing, which helps a lot with handling the aircraft because the position or location of the cargo as well as persons does not move or change. However, the take-off and landing positions as well as the forward flying position or mode are described more clearly in connection with the attached figures.

Further the structure construction is configured to receive an electric power source, such as batteries, to the first fuselage portion, and in particularly to the front portion of the first fuselage portion. According to an advantageous embodiment the location of at least portion of the power sources is configured to be moved or changed between the take-off, landing and/or flight modes or due to changes in loading. For example the location can be moved or changed in a direction of the longitudinal axis of the first and/or second fuselage portion, but according to an embodiment also in a lateral direction. In this way the position of the center of gravity can be changed and optimized (even during take-off, forward flying, hovering and landing) in view of the cargo or other load so that the position of the overall center of gravity is in an optimal area, or in other words so that the first and second fuselage portions are more or less in balance and that the aircraft can be controlled during take-off, forward flying, hovering and landing.

The present invention offers advantages over the known prior art, such as the supporting structure which allows easy and very fast turning of the supporting structure or the wing to the forward flight mode from the take-off position or transition to the flight position via a hovering mode, as well as opposite to the landing position from the forward flight mode. In addition the supporting structure of the invention can offer a simple and very durable structure, which is in addition very stable to land and to be parked on the ground, because the center of the gravity can be kept on an extremely low position in particularly during landing. Even if the supporting structure and the aircraft having the supporting structure is configured to perform in particularly vertical take-offs and landings, it has a highly aerodynamic structure and a low air resistance in the forward flying mode and thus enabling high airspeed with same or lower engine power than the prior art machines, which naturally decreases fuel consumption. Furthermore the aircraft of the invention is easy to load and unload, and the cargo will remain essentially at the same position during the whole flight, including also take-off and landing, because the second fuselage portion is hinged in relation to the first fuselage portion so that the second fuselage portion can remain essentially in the horizontal position during parking, landing, take-off, hovering and also during forward flying mode.

### BRIEF DESCRIPTION OF THE DRAWINGS

Next the invention will be described in greater detail with reference to exemplary embodiments in accordance with the accompanying drawings, in which:

FIGS. 1A-1B illustrate a perspective view of an exemplary aircraft having a structure construction in a forward flying mode according to an advantageous embodiment of the invention,

FIG. 2 illustrates a side view of an exemplary aircraft having a structure construction in a forward flying mode according to an advantageous embodiment of the invention,

FIG. 3 illustrates a side view of an exemplary aircraft having a structure construction in a take-off, landing and/or hovering mode according to an advantageous embodiment of the invention, and

FIGS. 4A-4B illustrate a perspective view of an exemplary aircraft having a structure construction in a take-off, landing and/or hovering mode according to an advantageous embodiment of the invention.

### DETAILED DESCRIPTION

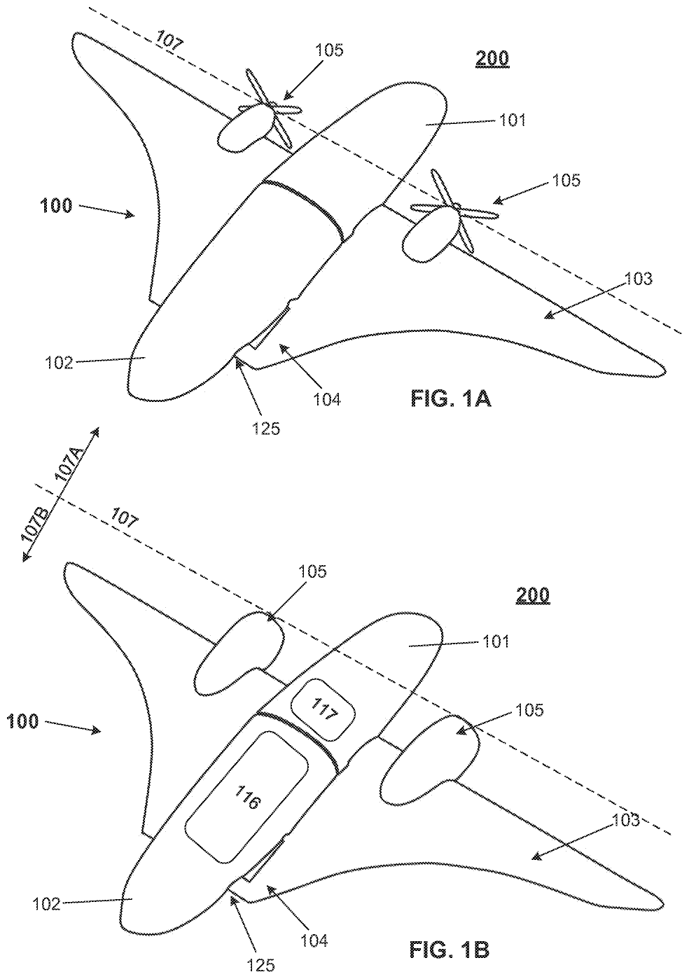

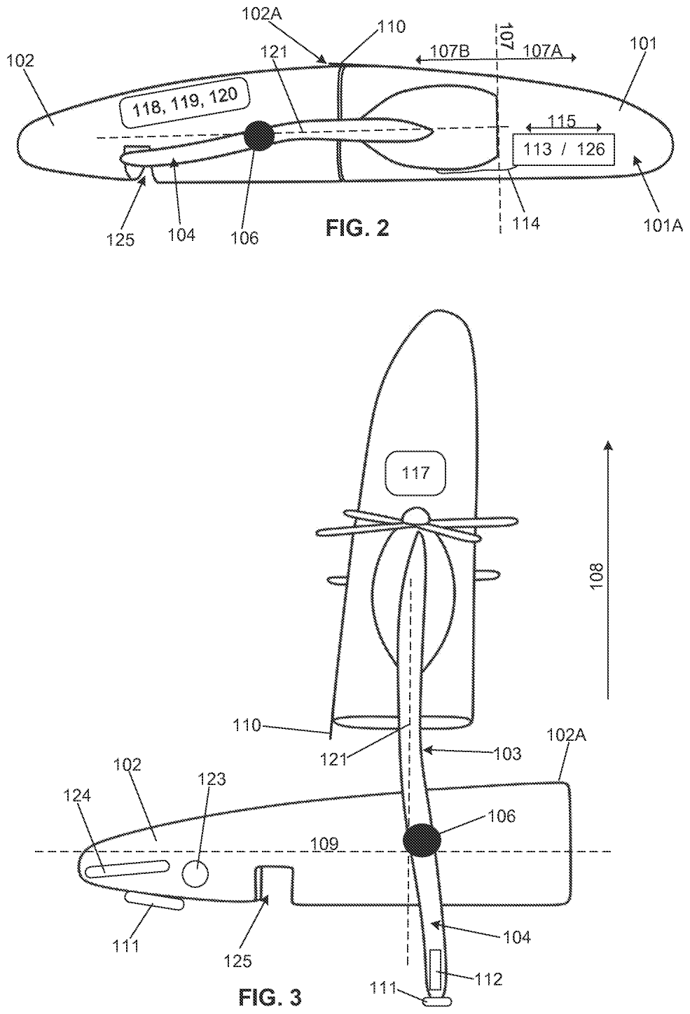

FIGS. 1A-1B illustrate a perspective view and FIG. 2 illustrates a side view of an exemplary aircraft 200 having a structure construction 100 in a forward flying mode according to an advantageous embodiment of the invention comprising first 101 and second 102 fuselage structure portions and wing 103. A supporting structure 104 for supporting the wing 103 and the first fuselage portion 101 is also depicted. The supporting structure 104 or the wing 103 has engines 105 provided with rotating propellers, as is the case in FIG. 1A or fans, as is the case in FIG. 1B.

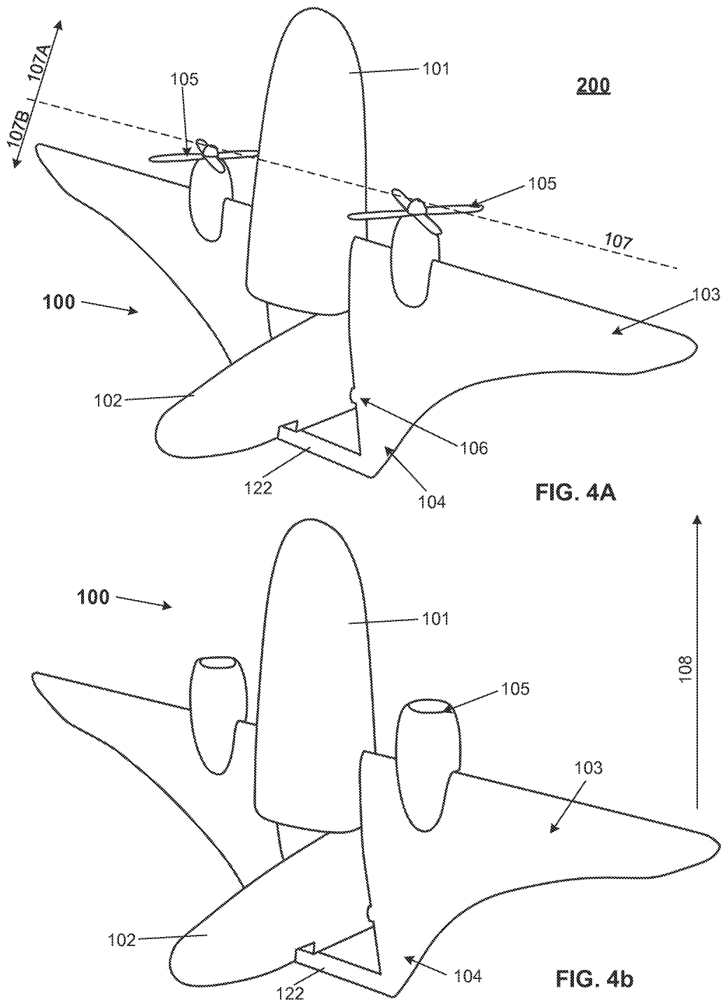

FIG. 3 illustrates a side view and FIGS. 4A-4B illustrate a perspective view of the exemplary aircraft 200 with the structure construction 100 in a take-off, landing and/or hovering mode according to an advantageous embodiment of the invention. As can be seen e.g. in FIGS. 2 and 3, the supporting structure 104 is configured to be hinged 106 to the second fuselage portion 102 so that the supporting structure 104 allows turning of said wing 103 and said first fuselage portion 101 in relation to the second fuselage portion 102 to a take-off and landing modes or positions (FIG. 3, 4A-4B), and to forward flying or cruising mode (FIG. 1A-1B, 2). In the forward flying mode the wing 103 and the first fuselage portion 101 (or their longitudinal axis 121) are turned via help of the supporting structure 104 essentially parallel to the longitudinal axis 109 of the second fuselage portion 102. In the landing, take-offs and hovering modes the wing 103 and the first fuselage portion 101 (or their longitudinal axis 121) are turned via help of the supporting structure 104 to an upward direction 108 and essentially perpendicular to the longitudinal axis 109 of the second fuselage portion 102.

In hovering, take-off and landing the first fuselage portion 101 is essentially above the second fuselage portion 102 and the second fuselage portion is clearly at the lower level, as can be seen especially in FIGS. 3, 4A-4B. The second fuselage portion 102 (or its longitudinal axis 109) is configured to remain essentially in a horizontal position or plane both during take-off and landing as well as during flight, parking, loading and unloading.

The second fuselage portion 102 comprises a cockpit, cabin and/or room 116 for persons and/or cargo. In addition the structure construction 104 is configured to receive an electric power source 113, such as batteries, advantageously to the first fuselage portion 101, and in particularly to the front portion 101A of the first fuselage portion 101. The structure comprises naturally also a power transmission 114 from the power source 113 at least to the engines 105, but also to other devices need for power supply. The structure construction 104 comprises also a moving member 126 for moving 115 or changing the location of at least portion of the power sources between the take-off, landing and/or flight modes or due to changes in loading. For example the location can be moved or changed in a direction of the longitudinal axis 121 (109) of the first 101 (and/or second 102) fuselage portion, but also a lateral direction is possible.

In addition in the forward flying mode the first fuselage portion 101 extends to the front 107A of the front line 107 of the engines 105 and the second fuselage portion 102 locates mainly and essentially at the rear side 107B of the front line 107 of the engines as can be seen in FIGS. 1A-1B and 2. The front line 107 of the engines 105 is a line where the propeller or fan locates. According to an example at least 20 or more advantageously at least 30%, of the mass of the of the whole structure construction 100 or the aircraft 200 locates in the front side 107A of the engine line 107 at least during transition for forward flight or hovering. This allows easy and fast turning of the supporting structure 104 or the wing 103 to the forward flight mode or transition flight position via hovering mode, and vice versa, for example.

The second fuselage portion 102 may also comprise a smaller auxiliary engine 123 or ailerons or stabilizers 124 for turning the second fuselage portion 102 when the aircraft already has certain airspeed, or for keeping or helping to keep the second fuselage portion 102 in a certain position, such as essentially in a horizontal positions, when the aircraft already has suitable airspeed.

In addition according to an embodiment the supporting structure 104 may comprise a locking device 125 for locking the supporting structure 104 together with the wing 103 and first fuselage portion 101 in desired locations in relation to the second fuselage portion 102. The locking device 125 may be e.g. a mechanical locking device 125, which supports the supporting structure 104 physically to a bottom portion of the second fuselage portion 102, when the supporting structure 104 is turned around the hinge 106 essentially parallel to said second fuselage portion 102 so to the flight mode. In addition the supporting structure 104 may comprise a crossbar 122 extending from the first side of the second fuselage portion 102 to the opposite side and thereby supporting the supporting structure 104 physically to a bottom portion of the second fuselage portion 102 (as can be seen in FIGS. 4A, 4B).

In addition according to an example the supporting structure 104, wing 103 or first fuselage portion 101 may comprise a locking device 110, advantageously a mechanical locking device, which supports the supporting structure 104, wing 103 or first fuselage portion 101 physically to a top portion 102A of said second fuselage portion 102 (see FIGS. 2 and 3), when the supporting structure is turned around the hinge 106 essentially parallel to said second fuselage portion 102, so to the flight mode. For example the supporting structure 104, wing 103 or first fuselage portion 101 may comprise a crossbar extending from the first side of the second fuselage portion 102 to the opposite side and thereby supporting the supporting structure 104, wing 103 or first fuselage portion 101 physically to a top portion of the second fuselage portion 102 (not shown).

The supporting structure 104 and/or the second fuselage portion 102 may also comprise a landing gear structure 111 for supporting the supporting structure 104 or structure construction especially in and after landing, and also on the ground, when parked. Moreover the supporting structure 104 or trailing edge of the wing 103 may comprise also a shock absorber 112 for damping any impacts in landing. The structure may also comprise an emergency parachute 117, such as a rocket parachute 117. The parachute 117 is advantageously located in the first fuselage portion 101 so that the center of gravity would easily turn the first fuselage portion into the upward direction for landing, as is depicted e.g. in FIG. 3.

Still in addition the aircraft 200 or the structure construction 100 comprises a data processing unit 118 and sensors 119 for determining positions of the first 101 and second 102 fuselage portions for example in relation to each other and to the ground during take-off, landing, hovering and forward flying. The data processing unit 118 is configured to control the speed and/or direction of the thrust of the engines 105 based on the data gathered by the sensors so that desired positions of the first and second fuselage portions 101, 102 are achieved and/or maintained. The direction of the thrust of the engines 105 can be advantageously controlled to control for example the turning and position of the first fuselage portion 101 (or the supporting structure 104 together with the wing 103 and the first fuselage portion 101) especially during the take-off and landing in relation to the second fuselage portion 102. As an example the engines 105 can be used for providing controllable air thrust in the vertical and/or side directions and thereby providing suitable airspeed and/or turning momentum of the aircraft. The direction of the thrust of the engines 105 can be controlled for example by turning the engines, propellers or the angle of attack of the propellers, or turning the fans. In addition the aircraft 200 or the structure construction 100 may comprise ailerons or stabilizers or guiding members for guiding air flow or draft or direction of the thrust.

In addition the aircraft 200 may comprise a device for measuring an altitude 120, such as a radar or laser or GPS positioning system, whereupon the aircraft is configured to use the altitude data to control speed and/or direction of the thrust of the engines and thereby performing said take-off, landing, hovering and forward flying. In particularly the structure construction 100 depicted in Figures are configured to allow the aircraft 200 to perform essentially vertical take-offs and landings (VTOL).

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

The features recited in dependent claims are mutually freely combinable unless otherwise explicitly stated.

1. A structure construction for an aircraft, comprising:
first and second fuselage portions,
at least one wing, and
a supporting structure for supporting said wing and said first fuselage portion,
wherein
said supporting structure or the wing is configured to be provided with at least one engine, and
wherein said supporting structure is configured to be hinged to the second fuselage portion, so that said supporting structure allows turning of said wing, said at least one engine and said first fuselage portion in relation to said second fuselage portion during take-off, landing modes and forward flying mode.

2. The structure construction of claim 1, wherein the first fuselage portion extends to a front of a front line of the engines to be received to the supporting structure or the wing.

3. The structure construction of claim 1, wherein the second fuselage portion locates, during the forward flying mode, at a rear side of a front line of the engines to be received to the supporting structure or the wing.

4. The structure construction of claim 1, wherein said wing and said first fuselage portion are configured to be turned via help of said supporting structure to an upward direction during hovering, take-off and landing in relation to said second fuselage portion.

5. The structure construction of claim 1, wherein said wing and said first fuselage portion are configured to be turned via help of said supporting structure essentially parallel to said second fuselage portion during flight.

6. The structure construction of claim 1, wherein said second fuselage portion is configured to remain essentially in a horizontal position both during take-off and landing as well as during flight, parking, loading and unloading.

7. The structure construction of claim 1, wherein at least 20 or more advantageously at least 30%, of the mass is configured to locate in a front side of an engine line.

8. The structure construction of claim 1, wherein the supporting structure comprises a locking device for locking said supporting structure with said wing and the first fuselage portion in desired locations in relation to the second fuselage portion, and wherein the locking device is configured to support said supporting structure physically to a bottom portion of said second fuselage portion, when said supporting structure is turned around a hinge essentially parallel to said second fuselage portion.

9. The structure construction of claim 1, wherein the supporting structure, the wing (103) or the first fuselage portion comprises a locking device, which is configured to support said supporting structure, the wing or the first fuselage portion physically to a portion of said second fuselage portion, when said supporting structure is turned around a hinge essentially parallel to said second fuselage portion.

10. The structure construction of claim 1, wherein the supporting structure and/or the second fuselage portion comprise a landing gear structure, advantageously a shock absorbing landing gear structure, configured to support said supporting structure or structure construction after landing to a desired upward direction.

11. The structure construction of claim 1, wherein the structure construction is configured to receive an electric power source, such as batteries, and wherein the structure construction is configured to move or change a location of at least portion of said power source between the take-off, landing and/or flight modes or due to changes in loading.

12. The structure construction of claim 1, wherein a cockpit and/or cabin or room for persons and/or cargo is arranged in the second fuselage portion.

13. An aircraft comprising a structure construction of claim 1, wherein said aircraft comprises at least two engines 405) for providing controllable air thrust and thereby providing suitable airspeed and/or turning momentum.

14. The aircraft of claim 13, wherein said engine is configured to control a direction of the thrust and thereby control the turning of the first fuselage portion especially during the take-off and landing in relation to said second fuselage portion.

15. The aircraft of claim 13, wherein the aircraft further comprises a data processing unit and sensors for determining positions of the first and the second fuselage portions during take-off, landing, hovering and forward flying and are configured to control the speed and/or direction of the thrust of the engines, so that desired positions of the first and the second fuselage portions are achieved and/or maintained.

16. The aircraft of claim 13, wherein the aircraft further comprises a device for measuring an altitude, such as a radar or a laser or a GPS positioning system, whereupon the aircraft is configured to use said altitude data to control speed and/or direction of the thrust of the engines and thereby perform said take-off, landing, hovering and forward flying.

17. The aircraft of claim 13, wherein the aircraft is configured to perform essentially vertical take-offs and landings.
